(19) United States
(12) Patent Application Publication
(10) Pub. No.: US 2013/0258861 A1
(43) Pub. Date: Oct. 3, 2013

(54) STANDBY METHOD AND MOBILE ROUTER

(71) Applicant: HUAWEI TECHNOLOGIES CO., LTD., Shenzhen (CN)

(72) Inventor: Tao Ma, Shanghai (CN)

(73) Assignee: Huawei Technologies Co., Ltd., Shenzhen (CN)

(21) Appl. No.: 13/758,102

(22) Filed: Feb. 4, 2013

(30) Foreign Application Priority Data
Mar. 28, 2012 (CN) 201210085653.5

(51) Int. Cl. H04W 52/02

(52) U.S. Cl. CPC H04W 52/0209
USPC 370/241; 370/311

(57) ABSTRACT

Embodiments of the present invention provide a standby method and a mobile router. In the embodiments of the present invention, a mobile router determines a working mode in current time, and then according to the working mode, obtains a standby processing cycle that corresponds to the working mode, so that when no terminal device performs a data service through the mobile router, the mobile router can execute a sleeping operation and an awakening operation according to the standby processing cycle, which can avoid a problem that in the prior art, after a mobile router enters a standby status, the mobile router is handed over between sleeping and awakening frequently according to a fixed frequency, thereby reducing power consumption of the mobile router according to an actual application requirement.

### CROSS-REFERENCE TO RELATED APPLICATIONS

This application claims priority to Chinese Patent Application No. 201210085653.5, filed on Mar. 28, 2012, which is hereby incorporated by reference in its entirety.

### FIELD OF THE INVENTION

Embodiments of the present invention relate to mobile router technologies, and in particular, to a standby method and a mobile router.

### BACKGROUND OF THE INVENTION

A mobile router is a mobilizable router, which may be connected to a terminal device in a wired manner or a wireless manner, and establish a data connection between the terminal device and the Internet through the Ethernet, a wireless fidelity (Wireless Fidelity, WIFI) network, or a cellular mobile communication network, so as to provide a data service for the terminal device. When no terminal device performs a data service through the mobile router, the mobile router may enter a standby status.

However, after the mobile router enters a standby status, the mobile router is handed over between sleeping and awakening frequently according to a fixed frequency, which causes power consumption of the mobile router. How to control the power consumption reasonably on the condition of satisfying a working requirement of a router becomes a problem.

### SUMMARY OF THE INVENTION

Embodiments of the present invention provide a standby method and a mobile router, so as to reduce power consumption of a mobile router.

In one aspect, a standby method is provided and includes:

determining, by a mobile router, a working mode in current time;

obtaining, by the mobile router, a standby processing cycle according to the working mode, where the standby processing cycle corresponds to the working mode; and

when no terminal device performs a data service through the mobile router, executing, by the mobile router, a sleeping operation and an awakening operation according to the standby processing cycle.

In another aspect, a mobile router is provided and includes:

a determining unit, configured to determine a working mode in current time;

an obtaining unit, configured to obtain a standby processing cycle according to the working mode, where the standby processing cycle corresponds to the working mode; and

an executing unit, configured to, when no terminal device performs a data service through the mobile router, execute a sleeping operation and an awakening operation according to the standby processing cycle.

It can be known from the foregoing technical solutions that, in the embodiments of the present invention, a mobile router determines a working mode in current time, and then according to the working mode, obtains a standby processing cycle that corresponds to the working mode, so that when no terminal device performs a data service through the mobile router, the mobile router can execute a sleeping operation and an awakening operation according to the standby processing cycle, which can avoid a problem that in the prior art, after a mobile router enters a standby status, the mobile router is handed over between sleeping and awakening frequently according to a fixed frequency, thereby reducing power consumption of the mobile router according to an actual application requirement.

### BRIEF DESCRIPTION OF THE DRAWINGS

To describe the technical solutions in the embodiments of the present invention or in the prior art more clearly, the accompanying drawings required for describing the embodiments or the prior art are briefly introduced in the following. Apparently, the accompanying drawings in the following description show some embodiments of the present invention, and persons of ordinary skill in the art may still derive other drawings from these accompanying drawings without creative efforts.

FIG. 1 is a schematic flow chart of a standby method according to an embodiment of the present invention;

FIG. 2 is a schematic structural diagram of a mobile router according to another embodiment of the present invention; and

FIG. 3 is a schematic structural diagram of a mobile router according to another embodiment of the present invention.

### DETAILED DESCRIPTION OF THE EMBODIMENTS

To make the objectives, technical solutions, and advantages of the embodiments of the present invention more comprehensible, the technical solutions in the embodiments of the present invention are clearly and completely described in the following with reference to the accompanying drawings in the embodiments of the present invention. Apparently, the embodiments to be described are merely a part rather than all of the embodiments of the present invention. All other embodiments obtained by persons of ordinary skill in the art based on the embodiments of the present invention without creative efforts shall fall within the protection scope of the present invention.

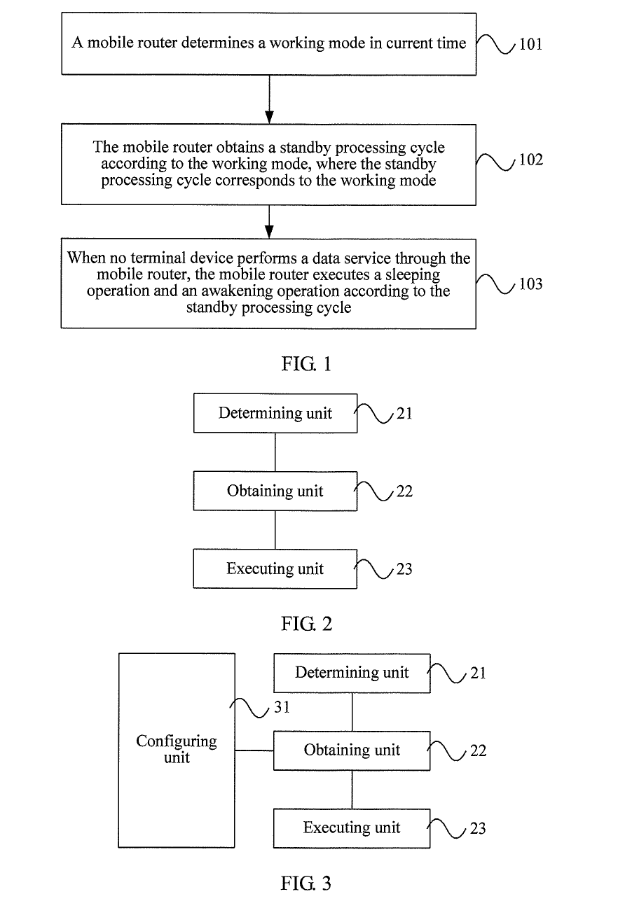

FIG. 1 is a schematic flow chart of a standby method according to an embodiment of the present invention. As shown in FIG. 1, the standby method in this embodiment may include:

101: A mobile router determines a working mode in current time.

In an optional implementation manner of this embodiment, before 101, the mobile router may further configure correspondence between a time range and a working mode, where the correspondence is used by the mobile router to determine the working mode in the current time. Specifically, the mobile router may configure the correspondence between the time range and the working mode according to user-defined correspondence. For the correspondence between the time range and the working mode, reference may be made to Table 1. One working mode corresponds to one type of standby processing cycle; and different working modes may correspond to different types of standby processing cycles.

TABLE 1
Correspondence between a time range and a working mode

| Time range | Working mode |
|---|---|
| 02:00-07:00 | Working mode 1 |
| 07:00-09:00 | Working mode 2 |
| 09:00-21:00 | Working mode 3 |
| 21:00-02:00 | Working mode 4 |

Further, the mobile router may further adjust and configure the correspondence between the time range and the working mode automatically on the basis of the foregoing configuration by analyzing a working condition of the mobile router in each time range.

102: The mobile router obtains a standby processing cycle according to the working mode, where the working mode corresponds to the working mode.

The standby processing cycle may include, but is not limited to, at least one of: a discontinuous reception (Discontinuous Reception, DRX) cycle and a beacon (Beacon) cycle.

In a radio communications system, for example: in a long term evolution (Long Term Evolution, LTE) system, in order to promote power-saving performance of a user equipment (User Equipment, UE), the DRX is proposed, which means that when the UE discontinuously receives a downlink scheduling command and downlink data and the downlink scheduling command and the downlink data do not need to be received, the UE may be in a sleep (sleep) status without monitoring a physical downlink control channel (Physical Downlink Control CHannel, PDCCH), so as to achieve an objective of power saving. Each DRX cycle first enters a transient continuous reception status (namely, an activation status) at the start, which is referred to as on duration (On Duration), and during this time, the UE needs to monitor the PDCCH, and its duration time is decided by an on-duration timer (On-Duration Timer).

For a WIFI access point (Access Point, AP), the WIFI AP may periodically broadcast network information of a WIFI network to which the WIFI AP is attached, and a length of this cycle may be referred to as a beacon cycle.

103: When no terminal device performs a data service through the mobile router, the mobile router executes a sleeping operation and an awakening operation according to the standby processing cycle.

The mobile router related in this embodiment is a portable mobile WIFI device, and the mobile router may downwardly provide a local area network (Local Area Network, LAN) service, for example: provide network-attached storage (Network-Attached Storage, NAS) file sharing, and digital living network alliance (Digital Living Network Alliance, DLNA) streaming media playing or recording for a user equipment through a USB module or a WIFI AP, and so on; and the mobile router may upwardly provide a wide area network (Wide Area Network, WAN) service, for example: provide an Internet (Internet) access service for the user equipment through an Ethernet module, a WIFI station (Station, STA for short) module or a cellular mobile communication network module, and so on.

A cellular mobile communication network related to the cellular mobile communication network module may include, but is not limited to, a global system for mobile communications (Global System for Mobile Communications, GSM), a general packet radio service (General Packet Radio Service, GPRS) system, a code division multiple access (Code Division Multiple Access, CDMA) system, a wideband code division multiple access (Wideband Code Division Multiple Access, WCDMA) system, a time division-synchronous code division multiple access (Time Division-Synchronous Code Division Multiple Access, TD-SCDMA) system, or a long term evolution (Long Term Evolution, LTE) system.

In an optional implementation manner of this embodiment, according to the DRX cycle, a cellular mobile communication network module of the mobile router may enter a sleep status and monitor the PDCCH.

In an optional implementation manner of this embodiment, according to the beacon cycle, a WIFI AP module of the mobile router may enter a sleep status and broadcast network information of a WIFI network to which the mobile router is attached.

In this embodiment, when no terminal device performs a data service through a mobile router, the mobile router determines a working mode in current time, and then according to the working mode, obtains a corresponding standby processing cycle, so that the mobile router can execute a sleeping operation and an awakening operation according to the standby processing cycle, which can avoid a problem that in the prior art, after a mobile router enters a standby status, the mobile router is handed over between sleeping and awakening frequently according to a fixed frequency, thereby reducing power consumption of the mobile router according to an actual application requirement.

It should be noted that: for each foregoing method embodiment, it is described as a series of action combination for simple description, however, persons skilled in the art should know that the embodiments of the present invention are not limited by the described action order, because some steps may be performed in other orders or performed at the same time according to the embodiments of the present invention. Second, persons skilled in the art should also know that, the embodiments described in the specification belong to exemplary embodiments, related actions and modules are not always necessary to the embodiments of the present invention.

In the foregoing embodiments, the description of each embodiment has its own focus. For a part that is not described in detail in a certain embodiment, reference may be made to a related description in another embodiment.

FIG. 2 is a schematic structural diagram of a mobile router according to another embodiment of the present invention. As shown in FIG. 2, the mobile router in this embodiment may include a determining unit 21, an obtaining unit 22, and an executing unit 23. The determining unit 21 is configured to determine a working mode in current time; the obtaining unit 22 is configured to obtain a standby processing cycle according to the working mode, where the standby processing cycle corresponds to the working mode; and the executing unit 23 is configured to, when no terminal device performs a data service through the mobile router, execute a sleeping operation and an awakening operation according to the standby processing cycle.

The standby processing cycle may include, but is not limited to, at least one of: a DRX cycle and a beacon cycle.

In an optional implementation manner of this embodiment, according to the DRX cycle, the executing unit 23 may specifically enter a sleep status and monitor a PDCCH.

In an optional implementation manner of this embodiment, according to the beacon cycle, the executing unit 23 may specifically enter a sleep status and broadcast network information of a WIFI network to which the mobile router is attached.

In an optional implementation manner of this embodiment, as shown in FIG. 3, the mobile router provided in this embodiment may further include a configuring unit 31, configured to configure correspondence between a time range and a working mode, where the correspondence is used by the determining unit 21 to determine the working mode in the current time.

In this embodiment, a mobile router determines a working mode in current time through a determining unit, and then according to the working mode, an obtaining unit obtains a standby processing cycle that corresponds to the working mode, so that when no terminal device performs a data service through the mobile router, an executing unit can execute a sleeping operation and an awakening operation according to the standby processing cycle, which can avoid a problem that in the prior art, after a mobile router enters a standby status, the mobile router is handed over between sleeping and awakening frequently according to a fixed frequency, thereby reducing power consumption of the mobile router according to an actual application requirement.

Persons skilled in the art may clearly understand that, for a purpose of convenient and brief description, for a detailed working process of the system, apparatus, and unit described in the foregoing, reference may be made to a corresponding process in the method embodiments, and details are not described herein again.

In the embodiments provided in the present application, it should be understood that the disclosed system, apparatus, and method may be implemented in other manners. For example, the described apparatus embodiment is merely exemplary. For example, the unit division is merely logical function division and may be another division during actual implementation. For example, multiple units or components may be combined or integrated into another system, or some features may be ignored or not be performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on multiple network units. A part or all of the units may be selected according to an actual need to achieve the objectives of the solutions in the embodiments.

In addition, functional units in the embodiments of the present invention may be integrated into one processing unit, or each of the units may exist alone physically, or two or more units are integrated into one unit. The integrated unit may be implemented in the form of hardware, or may also be implemented in the form of hardware plus a software functional module.

The integrated unit implemented in the form of software functional unit may be stored in a computer readable storage medium. The software functional unit is stored in a storage medium, and includes several instructions used to instruct a computer device (which may be a personal computer, a server, or a network device, and so on) to perform part of the steps of the methods according to the embodiments of the present invention. The storage medium includes: any medium that can store program codes, such as a U-disk, a removable hard disk, a read-only memory (Read-Only Memory, ROM), a random access memory (Random Access Memory, RAM), a magnetic disk, or an optical disk.

Finally, it should be noted that the foregoing embodiments are merely intended for describing the technical solutions of the present invention rather than limiting the present invention. Although the present invention is described in detail with reference to the foregoing embodiments, persons of ordinary skill in the art should understand that they may still make modifications to the technical solutions described in the foregoing embodiments or make equivalent substitutions to some technical features of the technical solutions, as long as these modifications or substitutions do not cause the essence of corresponding technical solutions to depart from the spirit and scope of the technical solutions in the embodiments of the present invention.

What is claimed is:

1. A standby method, comprising:
determining, by a mobile router, a working mode in current time;
obtaining, by the mobile router, a standby processing cycle according to the working mode, wherein the standby processing cycle corresponds to the working mode; and
when no terminal device performs a data service through the mobile router, executing, by the mobile router, a sleeping operation and an awakening operation according to the standby processing cycle.

2. The method according to claim 1, wherein the standby processing cycle comprises at least one of: a discontinuous reception DRX cycle and a beacon cycle.

3. The method according to claim 1, wherein the executing, by the mobile router, the sleeping operation and the awakening operation according to the standby processing cycle comprises:
according to the DRX cycle, entering, by a cellular mobile communication network module of the mobile router, a sleep status and monitoring a physical downlink control channel PDCCH.

4. The method according to claim 1, wherein the executing, by the mobile router, the sleeping operation and the awakening operation according to the standby processing cycle comprises:
according to the beacon cycle, entering, by a wireless fidelity WIFI access point AP module of the mobile router, a sleep status and broadcasting network information of a WIFI network to which the mobile router is attached.

5. The method according to claim 1, wherein before the determining, by the mobile router, the working mode in the current time, the method further comprises:
configuring, by the mobile router, correspondence between a time range and a working mode, wherein the correspondence is used by the mobile router to determine the working mode in the current time.

6. A mobile router, comprising:
a determining unit, configured to determine a working mode in current time;
an obtaining unit, configured to obtain a standby processing cycle according to the working mode, wherein the standby processing cycle corresponds to the working mode; and
an executing unit, configured to, when no terminal device performs a data service through the mobile router, execute a sleeping operation and an awakening operation according to the standby processing cycle.

7. The mobile router according to claim 6, wherein the standby processing cycle comprises at least one of: a discontinuous reception DRX cycle and a beacon cycle.

8. The mobile router according to claim 6, wherein the executing unit is specifically configured to:
according to the DRX cycle, enter a sleep status and monitor a physical downlink control channel PDCCH.

9. The mobile router according to claim 6, wherein the executing unit is specifically configured to:
according to the beacon cycle, enter a sleep status and broadcast network information of a wireless fidelity WIFI network to which the mobile router is attached.

10. The mobile router according to claim 6, wherein the mobile router further comprises a configuring unit, configured to:
configure correspondence between a time range and a working mode, wherein the correspondence is used by the determining unit to determine the working mode in the current time.
